(19) United States
(12) Patent Application Publication
(10) Pub. No.: US 2024/0426320 A1
(43) Pub. Date: Dec. 26, 2024

(54) METHOD FOR OPERATING A FAN, AND SYSTEM FOR CARRYING OUT SAID METHOD

(71) Applicant: ZIEHL-ABEGG SE, Künzelsau (DE)

(72) Inventors: Fabian MOELLER, Kunzelsau (DE); Jacob KRAUTH, Mainhardt (DE); Bjoern WENGER, Schrozberg (DE)

(21) Appl. No.: 18/687,484

(22) PCT Filed: Aug. 4, 2022
(86) PCT No.: PCT/DE2022/200178

§ 371 Date: Feb. 28, 2024

(30) Foreign Application Priority Data
Sep. 1, 2021 (DE) 10 2021 209 641.7

(51) Int. Cl. F04D 29/66; F04D 25/06; F04D 27/00

(52) U.S. Cl. CPC F04D 29/663; F04D 25/06; F04D 27/00

(57) ABSTRACT

A method for operating at least one fan. The fan having an electric motor, wherein, during operation of the fan, at least one measured value is recorded by means of at least one sensor that measures a sound pressure and/or a structure-borne sound vibration, the at least one measured value being used as a parameter by a computing unit. The computing unit determines acoustic and/or psychoacoustic characteristic values for at least one defined time interval and/or for at least one defined operating point. The fan is operated at permissible operating points in which the acoustic and/or psychoacoustic characteristic values lie in a defined range. The disclosure also relates to a system for carrying out the method.

### CROSS REFERENCE

This application is a national stage entry application under 35 U.S.C. 371 of PCT Patent Application No. PCT/DE2022/200178 filed on 4 Aug. 2022, which claims priority to German Patent Application No. 10 2021 209 641.7, filed on 1 Sep. 2021 the entire contents of each of which are incorporated herein by reference.

### FIELD

The present disclosure relates to a method for operating at least one fan. In addition, the present disclosure relates to a system for carrying out such a method.

### BACKGROUND

The use of fans, for example in air source heat pumps, is subject to multiple noise control ordinances. As such, for example the “Technische Anleitung zum Schutz Gegen Lärm” (TA Lärm) [Technical Guidelines for Noise Reduction] prescribes noise pollution guidance levels for residential and mixed use areas in the form of temporally averaged sound pressure levels in dB (A)—if need be additional surcharges for fan noise containing tonal components, for instance. Different noise pollution guidance levels apply for daytime and nighttime. Low limit values must be adhered to in particular at night. By way of example, these are 50 dB (A) in residential areas during the day, whereas they are 35 dB (A) at night.

Other parameters besides mere volume can contribute to whether noise is considered disagreeable by a person. As such, based on product classification, two fans from different manufacturers may have a similar A-rated sound pressure/sound power level at a similar operating point but the subjective perception of the two noises may still be completely different.

There is therefore a need to adapt fan noise such that it is felt to be agreeable, or not disagreeable, i.e. the sound should be as acoustically pleasant as possible. Optimization targets set in the development process should therefore be, among other things, high system efficiency but also low noise emission, since competitive advantages can be achieved as a result.

### SUMMARY

The present disclosure is therefore based on the object of organizing and developing a method for operating a fan in such a way that simple means are used to facilitate noise-optimized operation. In addition, a system for carrying out such a method is intended to be specified.

According to the disclosure, the above object is achieved, in an embodiment, by way of the features of claim 1. This claim specifies a method for operating at least one fan, the fan having an electric motor, wherein, during operation of the fan, at least one sensor is used to record at least one measured value, such as a sound pressure and/or a structure-borne sound vibration, the at least one measured value being used as a parameter by a computing unit in order to determine acoustic and/or psychoacoustic characteristic values for at least one defined time interval and/or for at least one defined operating point, and the fan being operated, in an embodiment, at permissible operating points at which the acoustic and/or psychoacoustic characteristic values lie in a defined range.

The underlying object is achieved for the system, in an embodiment, by way of coordinate claim 12. This claim specifies a system for carrying out the method as claimed in one of claims 1 to 11, having at least one fan, having an electric motor, at least one sensor for recording a measured value, in an embodiment a sound pressure and/or a structure-borne sound vibration, and a computing unit for determining acoustic and/or psychoacoustic characteristic values for at least one defined time interval and/or for at least one defined operating point.

Based on the present disclosure, it has initially been recognized that the underlying object can be achieved by determining acoustic and/or psychoacoustic characteristic values on the basis of measured values and operating the fan or fans in consideration of these acoustic and/or psychoacoustic characteristic values. The measured values are recorded by sensors, the measured values being a sound pressure, a structure-borne sound vibration or another measurable environmental influence. These measured values are used by a computing unit as parameters in order to determine the actual acoustic and/or psychoacoustic characteristic values. The method according to the disclosure and the system according to the disclosure allow applicable anti-noise pollution laws to be adhered to in an ideal manner. It is conceivable for noise pollution limit values dependent on the time of day to also be adhered to, for example by using a night operating profile (the most efficient operation possible when people are absent) and a day operating profile (the most acoustically pleasant sound when people are present) for operating the fan or fans. Based on the disclosure again, it is therefore possible to hide predefined, acoustically annoying operating points that can arise with different applications.

It is pointed out that features of the method according to the disclosure may have a form according to the apparatus. These features and the advantages achieved thereby may expressly be part of the system according to the disclosure.

In an embodiment, a hiding of impermissible operating points can be compensated for by way of shorter and/or longer operation at permissible operating points. This achieves the advantage that operation in an acoustically and/or psychoacoustically desired range is facilitated and in addition the necessary power is provided by the fan or fans.

According to one embodiment, it is conceivable for the acoustic and/or psychoacoustic characteristic value determined to be a loudness and/or a volume level and/or a sound pressure level and/or a sound power level and/or a specific frequency component, for example a third-octave level, and/or a tonality and/or a roughness and/or a sharpness and/or a fluctuation strength and/or a psychoacoustic annoyance and/or a pitch and/or an impulsiveness. These characteristic values have the advantage that they are an ascertainable and comparable indication of subjective, human perception.

In an embodiment, the manipulated variable used to adjust the operating point of the fan may be an operating time and/or a speed and/or a torque and/or a power consumption and/or an angle of attack and/or a nozzle cross section and/or a blade damper position in a flow duct and/or external hardware and/or other fans for noise suppression. It has been recognized that the above manipulated variables have an influence on at least one of the acoustic and/or psychoacoustic characteristic values under discussion, meaning that these characteristic values can be influenced in a specific way.

In an embodiment, the ascertained acoustic and/or psychoacoustic characteristic values can be taken as a basis for defining an automatic control, with the result that operation of the fan under this automatic control takes place. By way of example, the automatic control can take place as a result of an actual value of an acoustic and/or psychoacoustic characteristic value being compared with a target value of an acoustic and/or psychoacoustic characteristic value. It is therefore possible to adhere to a desired operating profile, or a desired operating point, for which, for example, the sound is as acoustically pleasant as possible for human beings and the environment, for instance as a result of very quiet operation or operation with very small tonal components. By way of example, the definition of a suitable control law can be taken as a basis for using the acoustic and/or psychoacoustic characteristic values for actuating the motor, for instance as a result of the direct comparison of the actual value with a target value or the direct comparison of the actual value with a limit value. These may be stored in a database, e.g. after an initialization startup. An initialization startup is generally understood to mean that the acoustic and/or psychoacoustic response over the aggregate of all or selected operating points is logged while one or more fans are being (re)commissioned for the first time. Individual applications of one or more fans can be taken into consideration for this. By adapting/altering at least one of the manipulated variables, for example speed, torque and/or one of the other said manipulated variables, the acoustic and/or psychoacoustic characteristic value could be adapted in accordance with the automatic control.

In an embodiment, a central automatic control may be produced on an electric motor of a fan. Such an embodiment is suitable in particular if just a single fan is arranged. When there are a plurality of fans, this arrangement has the advantage that each fan can easily be controlled independently of the other fans. Alternatively, it is conceivable for a decentralized automatic control, preferably for electric motors of multiple fans, to be produced. This allows the fans to be controlled as a unit, with the result that combinational effects can be used.

According to another embodiment, multiple fans may be arranged. A load distribution can be performed, with the result that the fans are collectively operated at a permissible operating point. By way of example, instead of operating two fans at full load, four fans can be operated at half load. Such a load distribution allows the fans as a whole to meet noise pollution limit values and noise pollution guidance levels.

In addition, it may be advantageous if adapting an acoustic and/or psychoacoustic characteristic variable in a specific way is used to at least reduce another acoustic and/or psychoacoustic characteristic variable. By way of example, raising a sound power level can be used to reduce tonality. Alternatively or additionally, multiple quieter fans can be used to mask the sound of another, louder fan. In addition, when multiple fans are operating, individual fans can alternatively or additionally be used to apply antiphase sound in a specific way in order to decrease or cancel out an annoying sound. So-called active noise cancelling is therefore produced.

In an embodiment, another parameter considered by the computing unit may be whether a person is present in the surroundings of the fan. If it is detected that no person is present, the apparatus can be operated at a louder operating point, for example.

In an embodiment, the measured values can be used to record anomalies during the operation of the fan. By way of example, this allows a bearing damage, a soiling, an imbalance, a material fatigue, a manufacturing defect, a resonance, a flow separation and/or a nozzle whistling to be detected. This achieves the advantage that, if a change in the acoustic response occurs during operation (for example as a result of soiling, damage, material fatigue, or the like), the operating range of the fan can be restricted as appropriate. This allows normal operation to be ensured until an acoustic anomaly is corrected.

In an embodiment, the sensor used may be an acceleration sensor and/or a sound pressure sensor and/or a soft sensor/virtual sensor and/or sensors for describing the operating state and/or the operating environment and/or the manipulated variables.

There are now various options for advantageously organizing and developing the teaching of the present disclosure. This may be accomplished by referring firstly to the claims subordinate to claim 1 and secondly to the explanation of exemplary embodiments of the disclosure with reference to the drawing that follows. In conjunction with the explanation of the exemplary embodiments of the disclosure with reference to the drawing, exemplary embodiments and developments of the teaching are also explained.

### BRIEF DESCRIPTION OF THE SEVERAL VIEWS OF THE DRAWINGS

FIG. 1 shows a schematic representation of an exemplary embodiment of a system according to the disclosure that is also used to explain the method according to the disclosure,

FIG. 2 shows a schematic representation of an example of the permissible range of a manipulated variable,

FIG. 3 shows a schematic representation of an example of an impermissible range of a manipulated variable, and

FIG. 4 shows a schematic representation of a permissible operating range.

### DETAILED DESCRIPTION OF THE DISCLOSURE

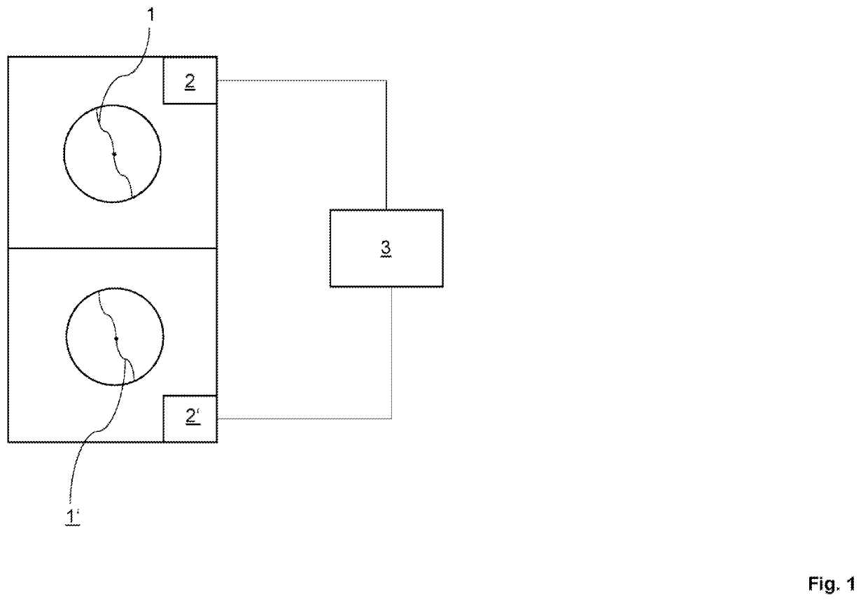

FIG. 1 shows a schematic representation of an exemplary embodiment of a system according to the disclosure. The system has two fans 1, 1′, which are driven by way of electric motors, not shown. In addition, there is provision for two sensors 2, 2′ and a computing unit 3. It is pointed out that the system may also have just a single fan and/or a single sensor.

The sensors 2, 2′ are used to record measured values, such as for example a sound pressure and/or a structure-borne sound vibration. These measured values are transferred to the computing unit 3, for example a computer. The computing unit 3 uses the measured values as parameters in order to determine acoustic and/or psychoacoustic characteristic values for at least one defined time interval and/or for at least one operating point, for example a loudness, a sound pressure level, a specific frequency component, etc.

This information is taken into consideration for operating the fans 1, 1′ at permissible operating points at which the acoustic and/or psychoacoustic characteristic values lie in a defined range, with the result that for example limit values are adhered to and/or people do not find the noise produced by the fans 1, 1′ disagreeable.

In addition, it is possible for the measurement signals recorded by the sensors 2, 2′ to be used to detect anomalies during the operation of the fans 1, 1′.

In an embodiment, the system is designed so that an automatic control can be defined on the basis of the ascertained acoustic and/or psychoacoustic characteristic values. The fans 1, 1′ can therefore be automatically controlled as a result of an actual value of a psychoacoustic characteristic value being compared with a target value of an acoustic and/or psychoacoustic characteristic value. The automatic control could also take place as a result of an actual value of an acoustic and/or psychoacoustic characteristic value being compared with a limit value of an acoustic and/or psychoacoustic characteristic value. It therefore becomes possible to adhere to a desired operating profile by adapting one or more manipulated variables, for example the motor actuation, when required.

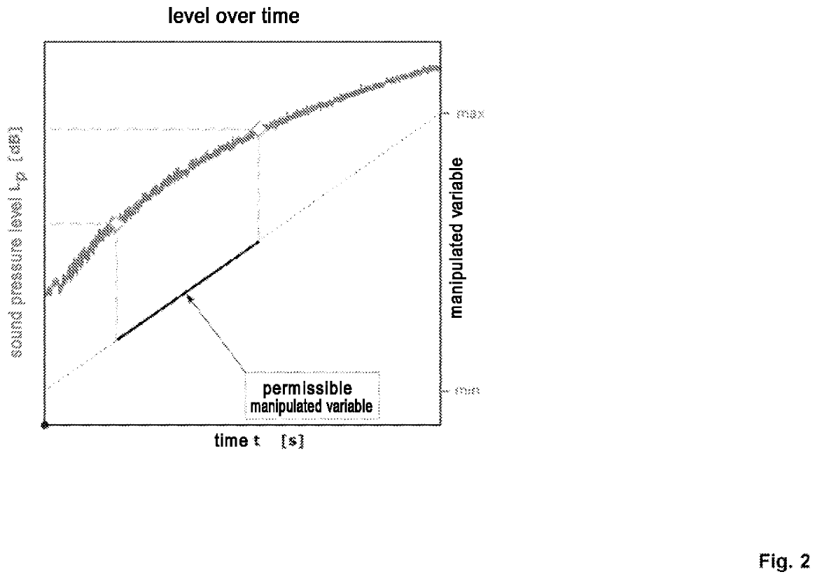

FIG. 2 shows a representation of a permissible range for a manipulated variable. The sound pressure level Lₚ is plotted as the acoustic and/or psychoacoustic characteristic value. In this representation, an almost monotonously rising curve for the sound pressure level Lₚ given a linear rise in the manipulated variable, for example engine speed, is assumed. The permissible range of the manipulated variable is defined by a lower and an upper sound pressure level Lₚ.

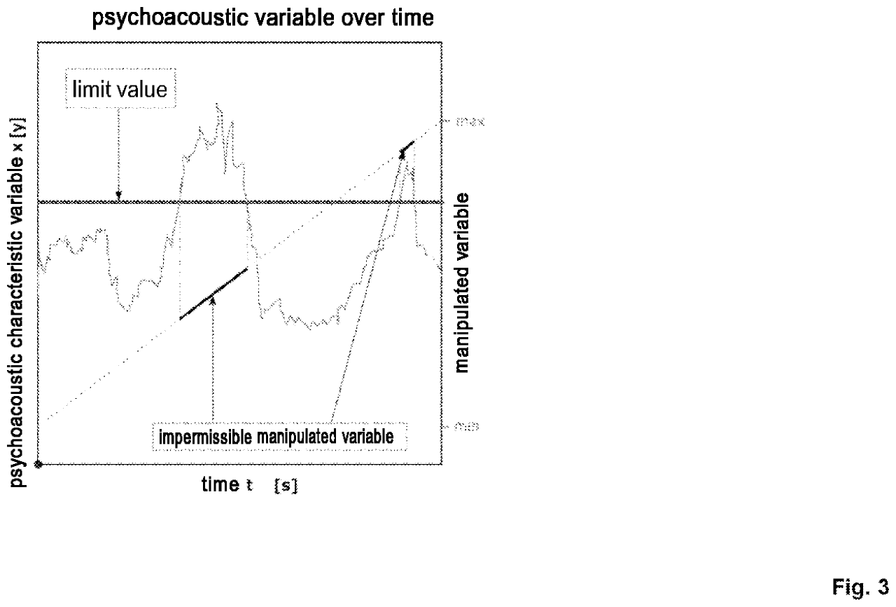

FIG. 3 shows a representation of an impermissible range for a manipulated variable. Here too, the sound pressure level Lₚ is plotted as the acoustic and/or psychoacoustic characteristic value. In this representation, it is assumed that no functional relationship exists between the sound pressure level Lₚ and a linear rise in the manipulated variable. The permissible range of the manipulated variable is delimited by a limit value.

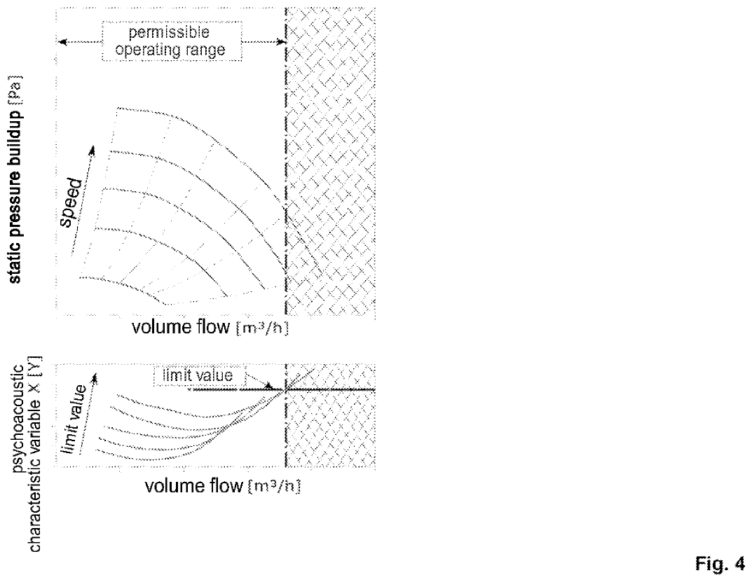

FIG. 4 shows the permissible operating range, or the permissible operating points, of a system according to the invention or a method according to the invention. The permissible operating range is limited by a limit value, which, in the case shown, is constant for all speeds.

In respect of other embodiments of the apparatus according to the disclosure, reference is made to the general part of the description and to the appended claims in order to avoid repetition.

Finally, it is expressly pointed out that the exemplary embodiments of the apparatus according to the disclosure that have been described above serve merely to discuss the claimed teaching, but do not restrict it to the exemplary embodiments.

### LIST OF REFERENCE SIGNS

1, 1′ Fan

2, 2′ Sensor

3 computing unit

1. A method for operating at least one fan, the fan having an electric motor, comprising:
using at least one sensor to record at least one measured value during operation of the fan, the measured value being at least one of a sound pressure and/or a structure-borne sound vibration,
the at least one measured value being used as a parameter by a computing unit to determine acoustic and/or psychoacoustic characteristic values for at least one defined time interval and/or for at least one defined operating point, and
the fan being operated at permissible operating points, which wherein the acoustic and/or psychoacoustic characteristic values lie in a defined range.

2. The method as claimed in claim 1, wherein a hiding of impermissible operating points is compensated for by way of shorter and/or longer operation at permissible operating points.

3. The method as claimed in claim 1, wherein a acoustic and/or psychoacoustic characteristic value determined is at least one of a loudness, a volume level, a sound pressure level, a sound power level and a specific frequency component.

4. The method as claimed in claim 1, characterized in that a manipulated variable used to adjust the operating point of the fan is at least one of an operating time, a speed a torque, a power consumption, an angle of attack, a nozzle cross section, a blade damper position in a flow duct, external hardware, and other fans for noise suppression.

5. The method as claimed in claim 1, wherein the acoustic and/or psychoacoustic characteristic values are taken as a basis for defining an automatic control, with the result that automatic operation of the fan takes place, as a result of at least one of:
an actual value of an acoustic and/or psychoacoustic characteristic value being compared with a target value of an acoustic and/or psychoacoustic characteristic value; and
an actual value of an acoustic and/or psychoacoustic characteristic value being compared with a limit value of an acoustic and/or psychoacoustic characteristic value.

6. The method as claimed in claim 5, wherein a central automatic control is produced:
on an electric motor of a fan; or
in a decentralized automatic control for electric motors of multiple fans.

7. The method as claimed in claim 1, wherein multiple fans are arranged and a load distribution is performed, with the result that the fans are collectively operated at a permissible operating point.

8. The method as claimed in claim 1, wherein an acoustic and/or psychoacoustic characteristic variable is adapted in a way to at least reduce another acoustic and/or psychoacoustic characteristic variable.

9. The method as claimed in claim 1, wherein another parameter considered by the computing unit is whether a person is present in the surroundings of the fan.

10. The method as claimed in claim 1, wherein the measured values are used to record anomalies during the operation of the fan for example a bearing damage, a soiling, an imbalance, a material fatigue, a manufacturing defect, a resonance, a separation and/or a nozzle whistling.

11. The method as claimed in claim 1, wherein the sensor is at least one of an acceleration sensor, a sound pressure sensor, a soft sensor/virtual sensor, sensors for describing the operating state, sensors for describing the operating environment; and manipulated variables.

12. A system for carrying out the method as claimed in claim 1, having at least one fan having an electric motor, at least one sensor for recording a measured value, including a sound pressure and/or a structure-borne sound vibration, and a computing unit for determining acoustic and/or psychoacoustic characteristic values for at least one defined time interval and/or for at least one defined operating point.

13. The method as claimed in 3, wherein the loudness, the volume level, the sound pressure level, the sound power level and the specific frequency component, comprises at least one of
a third-octave level,
a tonality,
a roughness;
a sharpness;
a fluctuation strength;
a psychoacoustic annoyance;
a pitch; and
an impulsiveness.

14. The method as claimed in claim 8, wherein the acoustic and/or psychoacoustic characteristic variable is adapted to at least one:
raise a sound power level to reduce tonality;
use multiple quieter fans to mask the sound of another, louder fan;
use individual fans, when multiple fans are operating, to apply antiphase sound in a specific way in order to decrease or cancel out an annoying sound.
